(19) United States
(12) Patent Application Publication
(10) Pub. No.: US 2023/0208257 A1
(43) Pub. Date: Jun. 29, 2023

(54) EARTHING CONTACT AND METHOD FOR DISSIPATING ELECTRICAL CURRENTS

(71) Applicant: SCHUNK TRANSIT SYSTEMS GMBH, Wettenberg (DE)

(72) Inventors: Ralf Hoerr, Biebertal (DE); Philipp Hornik, Reiskirchen (DE); Tom Nusch, Wettenberg (DE)

(21) Appl. No.: 17/925,994

(22) PCT Filed: May 20, 2020
(86) PCT No.: PCT/EP2020/064138

§ 371 Date: Nov. 17, 2022

(51) Int. Cl. H02K 11/40; H01R 39/26; H01R 39/39; H01R 39/20

(52) U.S. Cl. CPC H02K 11/40; H01R 39/26; H01R 39/39; H01R 39/20; H01R 39/24

(57) ABSTRACT

A ground contact and a method for conducting electric currents from a rotor part of a machine to a stationary stator part of the machine, the rotor part having an axis or shaft, the ground contact comprising a holder device connected to the stationary stator part of the machine in an electrically conductive manner and a contact realized as a flexible conductor having a free end disposed on a circumference of the rotor part and an end fastened on the holder device, the conductor being inherently stable such that a contact force can be applied to a contact surface for establishing an electrically conductive sliding contact between a sliding contact surface of the conductor and the circumference of the rotor part. The conductor is bendable such that the free end extends in the direction of a rotational axis of the rotor part when disposing the ground contact on the rotor part.

The present application is a national stage application filed under 35 U.S.C. § 371 of International Application No. PCT/EP2020/064 138, filed May 20, 2020, which is incorporated by reference in its entirety for all purposes.

The disclosure relates to a ground contact and to a method for conducting electric currents from a rotor part of a machine, in particular a vehicle, a rail vehicle or the like, to a stationary stator part of the machine, the rotor part having an axis or shaft, the ground contact comprising a holder device and a contact element, the holder device being able to be connected to the stationary stator part of the machine in an electrically conductive manner, the contact element being realized as a flexible conductor, the conductor having a free end disposed on a circumference of the rotor part and an end fastened on the holder device, the conductor being inherently stable in such a manner that a contact force is able to be applied to a contact surface for establishing an electrically conductive sliding contact between a sliding contact surface of the conductor provided for forming the sliding contact and the contact surface on the circumference of the rotor part.

U.S. Pat. No. 7,193,836 discloses a conductor device for conducting electrostatic charges from a shaft in which a carbon fiber arrangement made of a plurality of filaments is disposed on an annular holder disposed coaxially to the shaft. To form a physical contact with the shaft, shaft contact sections of the individual filaments are normally oriented to the shaft circumference. A physical contact between the filaments and the shaft circumference is therefore yielded only on the axial ends of the filaments. Owing to the normal orientation of the filaments to the shaft circumference, an incline of the filaments is yielded in the rotational direction depending on the rotational direction of the shaft. In particular when the rotational direction of the shaft is changed, the filaments are inclined in the opposite direction. This leads to the filaments possibly breaking and the carbon fiber assembly becoming frayed as a result of often changes of direction. An electric contact of the shaft is then no longer ensured in the desired manner.

Another ground contact is known from DE 10 2015 206 520 A1. With this ground contact, conductors which abut tangentially against the circumference of the axis of the vehicle are fastened on an annular holder. These conductors consist of carbon fibers and are fastened to the annular holder at their respective ends. A disadvantage in this instance is that the production of a ground contact of this kind is particularly cumbersome owing to the position and fastening of the carbon fibers on the annular holder. Furthermore, the position of the conductor has to be coordinated precisely with the corresponding diameter of the shaft in relation to the axis or the shaft so that the desired contact force can be exerted on the circumference of the shaft. Moreover, mounting this ground contact is cumbersome since a mounting aid is required for centering the annular holder together with the conductors clamped thereon on an axial end of the shaft and for sliding the annular holder and the conductors onto the circumference of the shaft using a prestressing formed between the conductors and/or a contact force without damaging the conductors.

The object of the disclosure at hand is therefore to propose a ground contact and a method for conducting electric current from a rotor part of a machine which has an axis or shaft and allows a safe contacting independently of the rotational direction using simple means.

This object is attained by a ground contact having the features of claim 1, a machine having the features of claim 18 and a method having the features of claim 19.

The ground contact according to the disclosure for conducting electric currents from a rotor part of a machine, in particular a vehicle, a rail vehicle or the like, to a stationary stator part of the machine, the rotor part having an axis or shaft, comprises a holder device and a contact element, the holder device being able to be connected to the stationary stator part of the machine in an electrically conductive manner, the contact element being realized as a flexible conductor, the conductor having a free end disposed on a circumference of the rotor part and an end fastened on the holder device, the conductor being inherently stable in such a manner that a contact force is able to be applied to a contact surface for establishing an electrically conductive sliding contact between a sliding contact surface of the conductor provided for forming the sliding contact and the contact surface on the circumference of the rotor part. The conductor is formed so as to be bendable in a curved manner between the free end and the fastened end such that the free end extends towards a rotational axis of the rotor part when disposing the ground contact on the rotor part.

According to the disclosure, the contact element is formed as a flexible electric conductor which can be contacted with the circumference of the rotor part and/or the axis or shaft of the machine. For this purpose, it is generally of no importance whether the rotor part is an axis or a shaft. On the circumference, the axis or shaft has a circumferential contact area on which the conductor can be abutted against the shaft. The conductor is firmly fixated on the holder device by the fastened end, the free end abutting against the circumference. Since the conductor is electrically conductive, the electrically conductive sliding contact can be produced between the rotor part and the stator part via which the electrostatic charges can be conducted. The elasticity and thus inherent stability of the conductor allows prestressing the conductor on the circumference of the shaft and thus to apply a contact force to the shaft. Furthermore, the conductor is fastened in such a manner to the holder device that the free end of the conductor extends in the direction of a rotational axis of the rotor part. The free end accordingly is inclined in the direction of the rotational axis or is precisely oriented according thereto. The inherently stable form of the conductor, which is elastic in one direction, can prevent the conductor from becoming oriented in the direction of a rotational axis via the free end. A movement of the conductor dependent on the rotational direction and a fraying at the ends can thus be prevented, resulting in a prolonged service life of the ground contact. Nevertheless, the conductor can shape itself to the shaft and/or the contact surface of the circumference of the shaft, whereby a reliable contacting is achieved. Before the ground contact is mounted on the shaft, the conductor can be essentially straight, meaning the conductor becomes deformed when axially sliding the ground contact onto the rotor part and/or the shaft or when radially assembling the ground contact on the rotor part and/or shaft. The conductor is bent in a curved manner, e.g., having a radius, between the free end and the fastened end, whereby a prestressing is created with the contact force. In this context, the conductor is formed such that merely a bending of the conductor in this manner results in the free end extending in the direction of the rotational axis of the rotor part. A shape of the conductor is consequently formed such that merely a bending of the conductor is possible essentially in one direction. An undesired deforming of the conductor can thus be prevented and a mounting of the ground contact on an axis or shaft and/or a rotor part of a machine is significantly simplified.

The free end of a section of the conductor can be disposed parallel in relation to the rotational axis. The free end of the conductor can be bent such in the direction of the rotational axis of the rotor part that the section of the conductor extends in part parallel in relation to the rotational axis of the rotor part starting from the free end. Thus, not only a punctual support and/or a sliding contact on the contact surface can be formed on the circumference, but at least one support of a linear or even sectionally rectangular sliding contact surface of the conductor can be formed on the contact surface of the circumference. An electrically conductive connection can thus be formed even more reliably.

The fastened end can be disposed on the holder device so as to extend transversally, preferably orthogonally, to the rotational axis of the rotor part. The fastened end accordingly extends essentially perpendicular in relation to the rotational axis but can also be inclined at an obtuse angle, for example, in relation to the rotational axis. If the free end extends in the direction of the rotational axis, an angle of essentially 90° can be formed between the free end and the fastened end. Nevertheless, it also becomes possible to use the ground contact for different circumferences and diameters of rotor parts as the curved bendability of the conductor allows a large tolerance compensation. The ground contact therefore does not have to be adapted to a determined diameter of a rotor part but can also be used for rotor parts within a diameter range. The ground contact can thus be produced in a standardized and inexpensive manner.

The conductor can be formed having a rectangular cross section at least in sections. To this end, the rectangular cross section is formed such at least in an area of the conductor bendable in a curved manner that the conductor can be bent only in the direction of the rotational axis. In particular the rectangular cross section allows forming the conductor so as to be bendable in a defined direction. In general, however, it is also conceivable for the cross section of the conductor to have a different shape which ensures this bendability. A longitudinal axis of the rectangular cross section and/or a neutral bending line of the conductor cross section extends so as to have no intersection in relation to a cross section of the rotor part.

Preferably, the conductor can be realized as a conductor strip. With a strip-shaped conductor, a height-to-breadth ratio of a cross section can be 1:10 or more, for example. A strip-shaped conductor can be easily fastened to the holder device and be disposed on the rotor part using little installation space.

Furthermore, the conductor can be made predominantly of carbon. Thus, a possible corrosion of the conductor can be prevented. At the same time, little friction and/or a dry lubrication of the conductor is yielded at the circumference of the rotor part, meaning maintenance is essentially no longer required.

The conductor can be made of carbon fibers. The carbon fibers can be realized in a structured carbon fiber assembly, for example as a fiber braid. Moreover, it can be intended for the conductor to be made of different electrically conductive fibers alternatively. Furthermore, it is possible for the conductor to be made of a fiber braid made of carbon fibers and metal fibers. The metal fibers can consist of aluminum, copper, silver, gold or alloys of these metals.

The conductor can be made of a layer of felt or fleece. The layer made of a textile fabric can form a conductor strip. The felt or the fleece can consist of electrically conductive fibers, for example carbon fibers. A felt or a fleece is elastic because of the unstructured position of the fibers. Furthermore, a conductor formed in this manner is resistant to impurities since oil or dirt particles on the circumference of the rotor part can be absorbed by the felt or the fleece. A contacting is only marginally impacted by oil or dirt particles.

The conductor can further be made of a plurality of layers in a stack arrangement. By means of a plurality of layers, a precisely defined contact force can be easily produced. For instance, the layers having the same or different geometry can be disposed in the manner of an elliptic spring or leaf spring so as to be superjacent, meaning a spring bundle is formed having a desired spring characteristic curve. Depending on the desired contact force, a contact pressure can be adjusted and/or varied to the circumference of the rotor part via the number of layers.

It is particularly advantageous if the conductor is infiltrated with pyrolytic carbon. If the conductor is made of fibers, for example, in particular carbon fibers, the coating made of pyrolytic carbon can serve to compact a contact surface of the conductor and to form a sheath supporting the corresponding fiber braid. The infiltration with pyrolytic carbon and/or a coating of the fibers provides the desired elastic properties of the conductor having a rigidity which can be impacted in particular by a thickness of the coating of the fibers. A coating of the carbon fibers using chemical vapor infiltration (CVI) has proven particularly advantageous, as this method not only provides a superficial coating of the conductor, but moreover also ensures binding forces are formed between the individual filaments of the fiber braid. In this context, the fiber braid can be made of a unidirectional fiber strand which extends in the longitudinal direction of the conductor and has filaments extending essentially parallel to each other, meaning capillarity is formed by the fiber gaps, the capillarity enabling exploiting capillary effects for sluicing fat or liquids from the circumference of the rotor part.

The holder device can have a stationary annulus and at least one pressure element, the fastened end of the conductor being able to be connected to the holder device between the annulus and the pressure element in a force-fitting, form-fitting and/or substance-to-substance bonded manner. The holder device consists of at least two components and can thus be produced particularly easily and inexpensively. For this purpose, the pressure element can be realized such that the fastened end of the conductor is clamped between the annulus and the pressure element. This can take place via screwing, pressing or cramping, for example. Alternatively or additionally, the conductor can also be glued, soldered or welded on the annulus, depending on the material pairing.

In one embodiment, the annulus can be formed so as to be circular and to have an axial abutment surface for the conductor, the pressure element being able to be formed as a circular ring and to be pre-stressed against the abutment surface. The annulus can be at least disc-shaped, the conductor being able to be disposed on the axial abutment surface and be pressed on the annulus via the pressure element, which can also be disc-shaped. Alternatively, the annulus and/or the pressure element can have a square outer contour. The conductor is accordingly clamped between the annulus and the pressure element. A connection between the annulus and the pressure element can be realized by a simple screw connection or pressing them into each other, for example.

An inner diameter of the abutment surface can be approximated to an outer diameter. This allows ensuring that the ground contact is centered on the rotor part using the inner diameter of the abutment surface. The inner diameter forms a mounting aid for the ground contact, since a radial offset of the ground contact or a tilting of the ground contact is possible in only a defined tolerance range when sliding the ground contact on the circumference of the rotor part.

The abutment surface and/or the pressure element can form at least one bump for clamping and/or for securing the conductor in a form-fitted manner. The bump can be a material elevation on the abutment surface and/or on the pressure element. For instance, a plurality of bumps or grooves can be provided with respect to a cross section of the abutment surface or the pressure element which can exert a large clamping force and secure the conductor in a form-fitted manner when assembling the annulus and the pressure element. Alternatively or additionally, a recess can be formed in the conductor into which the bump engages to prevent the conductor from becoming turned on the abutment surface and/or the pressure element. At the same time, the bump can serve as a spacer element for forming a precise distance between the abutment surface and the pressure element in order to ensure a defined clamping of the conductor.

An outer diameter of the annulus can be formed by a radial shoulder, the outer diameter together with an inner diameter being able to form a press fit in the stator part. A longitudinal cut surface of the annulus can consequently be L-shaped, the radial and a second leg being able to form the axial abutment surface. The ground contact can thus be simply pressed into, for example, a casing lid, resulting in a good electrical contact being formed between the casing lid and the ground contact without requiring further mounting elements. It is also possible to mount the ground contact together with the casing lid on the rotor part.

In one embodiment, the ground contact can be formed to be connectable in a radially divisible manner. The holder device can consist of two semicircles, which can be laid around the circumference of the rotor part and can be connected to each other and be divided again correspondingly. If the holder device is made of an annulus and a pressure element, the annulus and the pressure element can each be formed so as to be divisible. A sliding onto an end of the rotor part is then no longer required so that the ground contact can also be used for shaft sections or axis sections which are not accessible from one end.

The ground contact can comprise at least two, three, four or more conductors, which can be disposed coaxially, preferably symmetrically, on the holder device in relation to the rotational axis. The conductors can be spaced apart equidistantly from each other in a circumferential direction of the rotor part, preferably all conductors being able to be disposed in a shared shaft contact plane which extends orthogonal to the rotational axis of the rotor part. It can then also always be ensured that the ground contact is disposed coaxially in relation to the circumference. Mounting the ground contact on the circumference and the rotor part is also significantly simplified since the ground contact centers itself.

The annulus and/or the pressure element can each be formed in one piece. A one-piece ring, for example, or a circular ring can be easily produced by lathing, stamping, pressing, deep-drawing, laser cutting etc. A holder device realized in such a manner is particularly well suited for being mounted on free axial or shaft ends.

The machine according to the disclosure comprises a ground contact according to the disclosure for conducting electric currents from a rotor part having an axis or a shaft to a stationary stator part of the machine.

In the method according to the disclosure, electric currents are conducted from a rotor part of a machine, in particular a vehicle, a rail vehicle or the like, to a stationary stator part of the machine, the rotor part having an axis or shaft, by using a ground contact comprising a holder device and a contact element, the rotor part having an axis or shaft, the holder device being connected to the stationary stator part of the machine in an electrically conductive manner, the contact element being realized as a flexible conductor, the conductor having a free end disposed on a circumference of the rotor part and an end fastened on the holder device, an electrically conductive sliding contact being formed between a sliding contact surface of the conductor and a contact surface on the circumference of the rotor part, the conductor being inherently stable in such a manner that a contact force is applied to the contact surface. The conductor is formed in a curved manner between the free end and the fastened end, the free end extending towards a rotational axis of the rotor part. For the advantages of the method according to the disclosure, reference is made to the description of advantages of the ground contact according to the disclosure.

Further advantageous embodiments of the method are derived from the descriptions of features of the dependent claims referring to claim device 1.

In the following the disclosure is described in more detail with reference to the attached drawings.

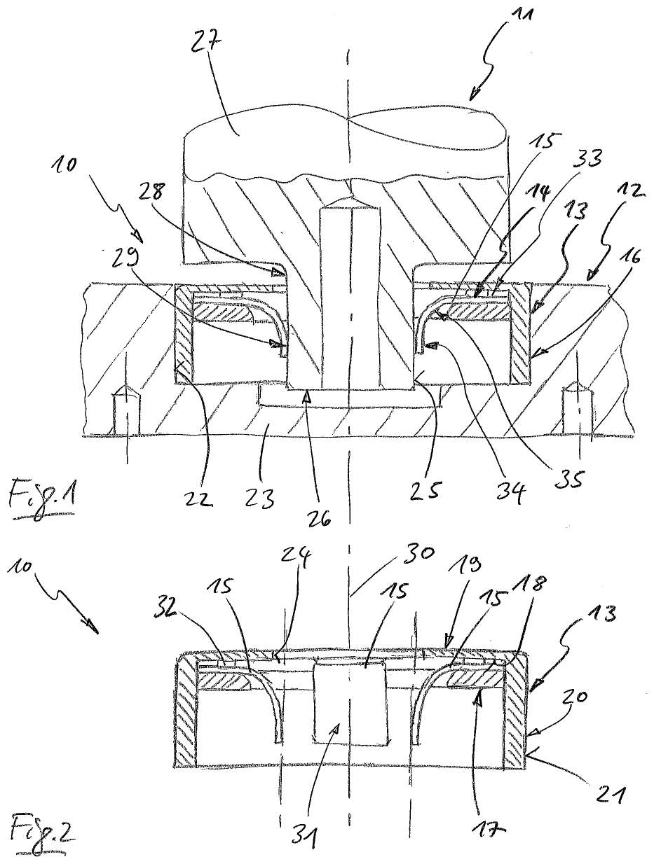

FIG. 1 shows a longitudinal cut of a ground contact in a mounting configuration having a rotor part and a stator part;

FIG. 2 shows a longitudinal cut of the ground contact.

FIGS. 1 and 2 show cut views of a ground contact 10, ground contact 10 being shown in conjunction with a rotor part 11 and a stator part 12 on a machine (not illustrated) in FIG. 1 while the ground contact in FIG. 2 is shown alone. Ground contact 10 serves for conducting electric currents from rotor part 11 to stator part 12 and vice versa. Ground contact 10 comprises a holder device 13 and a contact element 14, which is formed by a conductor 15. Holder device 13 is essentially made of a stationary annulus 16 and a pressure element 17. Annulus 16 is circular and forms an axial abutment surface 18. Pressure element 17 is formed as a circular arc 19 and inserted into annulus 16. Annulus 16 further forms a radial shoulder 20 having an outer diameter 21, outer diameter 21 and/or annulus 16 being inserted into an inner diameter 22 of a casing lid 23 of stator part 12. Via a press fit between outer diameter 21 and inner diameter 22, a good electric contacting and a sufficient fastening of ground contact 10 is ensured on casing lid 23.

Furthermore, annulus 16 is formed having an inner diameter 24, which is approximated to an outer diameter 25 of a pin 26 of a shaft 27 of rotor part 11. Shaft 27 is thus radially surrounded by ground contact 10. A circumference 28 of pin 26 forms a contact surface 29 for forming a sliding contact with conductor 15. Ground contact 10 comprises four conductors 15 in this instance which are disposed coaxially to a rotational axis 30 of rotor part 11 and are spaced apart equidistantly from each other in relation to one another with respect to circumference 28. Conductors 15 are each realized as conductor strips 31 which are clamped between annulus 16 and pressure element 17. Conductor strip 31 is formed via a one-piece fleece made of carbon fibers. For securing conductors 15, a bump 32 is formed on abutment surface 18 in each instance, bump 32 engaging in a recess (not visible) in conductor 15. Pressure element 17 is screwed to annulus 16 via screws (not illustrated) or a thread connection and thus clamped against abutment surface 18 with conductors 15.

Conductors 15 are essentially made of carbon fibers, which are infiltrated with pyrolytic carbon and are thus elastic. A fastened end 33 of conductors 15 clamped on holder device 13 is disposed essentially orthogonally with respect to rotational axis 30, a free end 34 of conductor 15 being bent so far in relation to fastened end 33 that free end 34 extends parallel to rotational axis 30. Between fastened end 33 and free end 34, a curve 35 is formed via this bending.

When mounting ground contact 10 on pin 26, free ends 34 also initially extend orthogonally in relation to rotational axis 30, but are deformed to the illustrated shape or curve 35 as a consequence of being slid onto pins 26, meaning a contact force is exerted on circumference 28 via elastic conductors 15. A direction of the deformation of conductors 15 is always ensured by the fact that conductors 15 are strip-shaped. The orientation of conductors 15 is then not even impacted by a rotational direction of rotor part 11. Furthermore, a particularly good electrical contacting of rotor part 11 can be ensured as conductors 15 adapt to different diameters owing to the elastic properties of conductors 15 and can shape themselves to fit around circumference 28 to a certain extent, whereby a particularly large contact surface 29 is formed.

1. A ground contact for conducting electric currents from a rotor part of a machine to a stationary stator part of the machine, the rotor part having an axis or shaft, the ground contact comprising a holder device and a contact element, the holder device being able to be connected to the stationary stator part of the machine in an electrically conductive manner, the contact element being realized as a flexible conductor, the conductor having a free end disposed on a circumference of the rotor part and an end fastened on the holder device, the conductor being inherently stable in such a manner that a contact force is able to be applied to a contact surface for establishing an electrically conductive sliding contact between a sliding contact surface of the conductor provided for forming the sliding contact and the contact surface on the circumference of the rotor part, wherein the conductor is formed between the free end and the fastened end so as to be bendable in a curved manner such that the free end extends in the direction of a rotational axis of the rotor part when disposing the ground contact on the rotor part.

2. The ground contact according to claim 1, wherein the free end of a section of the conductor is disposed parallel in relation to the rotational axis.

3. The ground contact according to claim 1, wherein the fastened end is disposed on the holder device so as to extend transversally to the rotational axis of the rotor part.

4. The ground contact according to claim 1, wherein at least sections of the conductor are realized having a rectangular cross section.

5. The ground contact according to claim 1, wherein the conductor is realized as a conductor strip.

6. The ground contact according to claim 1, wherein the conductor is made predominantly of carbon.

7. The ground contact according claim 1, wherein the conductor is made of carbon fibers.

8. The ground contact according to claim 1, wherein the conductor is made of a layer of felt or fleece.

9. The ground contact according to claim 8, wherein the conductor is made of a plurality of layers in a stack arrangement.

10. The ground contact according to claim 1, wherein the conductor is infiltrated with pyrolytic carbon.

11. The ground contact according to claim 1, wherein the holder device has a stationary annular body and at least one pressure element, the fastened end of the conductor being connected to the holder device between the annular body and the pressure element in a force-fitting, form-fitting and or substance-to-substance bonded manner.

12. The ground contact according to claim 11, wherein the annular body is circular having an axial abutment surface for the conductor, the pressure element being an annulus and being able to be clamped against the abutment surface.

13. The ground contact according to claim 12, wherein an inner diameter of the abutment surface approximates an outer diameter of the contact surface.

14. The ground contact according to claim 12, wherein the abutment surface and/or the pressing element forms at least one bump for clamping and/or for securing the conductor in a form-fitting manner.

15. The ground contact according to claim 11, wherein an outer diameter of the annular body is formed by a radial shoulder, the outer diameter together with the inner diameter forming a press fit in the stator part.

16. The ground contact according to claim 1, wherein the ground contact is formed to be connectable in a radially divisible manner.

17. The ground contact according to claim 1, wherein the ground contact comprises at least two conductors which are disposed coaxially on the holder device in relation to the rotational axis.

18. A machine having a ground contact according to claim 1, for conducting electric currents from a rotor part to a stationary stator part, the rotor part having an axis or shaft.

19. A method for conducting electric currents from a rotor part of a machine, to a stationary stator part of the machine having a ground contact comprising a holder device and a contact element, the rotor part having an axis or shaft, the holder device being connected to the stationary stator part of the machine in an electrically conductive manner, the contact element being realized as a flexible conductor, the conductor having a free end disposed on a circumference of the rotor part and an end fastened on the holder device, an electrically conductive sliding contact being formed between a sliding contact surface of the conductor and a contact surface on the circumference of the rotor part, the conductor being inherently stable in such a manner that a contact force is applied to the contact surface, wherein the conductor is formed in a curved manner between the free end and the fastened end, the free end extending in the direction of a rotational axis of the rotor part.

20. The method according to claim 19, wherein an annulus or intermediate arc is formed when the ground contact is slid onto or radially assembled on the rotor part in the progression of the conductor between the free end and the fastened end.
